(19) United States
(12) Patent Application Publication
(10) Pub. No.: US 2006/0243708 A1
(43) Pub. Date: Nov. 2, 2006

(54) Laser machining apparatus, laser machining method and manufacturing method of semiconductor device

(76) Inventor: Hiroshi Ikenoue, Nankoku-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/412,046

(22) Filed: Apr. 27, 2006

(30) Foreign Application Priority Data
Apr. 28, 2005 (JP) 2005-132801

(51) Int. Cl. B23K 26/03; B23K 26/38

(52) U.S. Cl. 219/121.62; 219/121.7

(57) ABSTRACT

A laser machining apparatus includes a laser irradiating part having a laser oscillator and a beam shape converting mechanism, an optical detecting part that detects reflected light from a workpiece by a laser of a specific wavelength emitted from the laser irradiating part, and a laser control part that controls at least one of the laser oscillator and the beam shape converting mechanism based on a detection result of the optical detecting part. The optical detecting part selectively detects light of the specific wavelength.

### CROSS-REFERENCE TO RELATED APPLICATIONS

This application is based upon and claims the benefit of priority from the prior Japanese Patent Application No. 2005-132801, filed on Apr. 28, 2005; the entire contents of which are incorporated herein by reference.

### BACKGROUND OF THE INVENTION

1. Field of the Invention

The present invention relates to a laser machining apparatus, a laser machining method and manufacturing method of a semiconductor device and particularly relates to a laser machining apparatus including a mechanism which controls machining conditions while monitoring the machining state of a workpiece in real time, and a laser machining method and manufacturing method of a semiconductor device.

2. Description of the Related Art

Conventionally, the laser machining technique is used for applying microprocessing such as perforating, marking, scribing and trimming to electronic components and the like including semiconductor devices, and is also used for cutting/welding. In the manufacturing process of a semiconductor device, for example, in the lithography process step, before performing alignment for aligning the positions of a pattern already formed on a semiconductor substrate and a pattern to be exposed, the method for selectively removing an opaque film formed on an alignment mark by irradiating a laser to the opaque film is used. However, this method has the problem that damage occurs to the film which is located under the opaque film to be removed during laser machining and a critical defect that causes characteristic deficiencies of the device occurs.

In order to solve the problem, there are proposed the methods of monitoring the machining state of a workpiece in real time, detecting whether a machined hole reaches a desired depth or not, and properly changing the machining conditions so that damage does not occur to the base film based on the detection result (for example, refer to Japanese Patent Laid-Open No. 2004-106048 (pages 9 to 12, FIG. 1) and Japanese Patent Laid-Open No. 2004-528991 (page 13, FIG. 7)).

According to the proposal described in Japanese Patent Laid-Open No. 2004-106048, an observation optical system having a CCD camera is installed coaxially with an irradiation optical system which irradiates a laser to a workpiece, the machining state of the workpiece is picked up by the CCD camera and is outputted as an image signal, and the machining conditions are changed based on the image signal. However, since change in reflection and emission intensity from the workpiece by laser irradiation is large, time is required for lighting control for picking up the workpiece with the CCD camera. Laser machining of the workpiece progresses while lighting control is conducted, and therefore, the machined hole exceeds the desired depth during lighting control. Therefore, in order to suppress an excessive machining amount exceeding the desired depth during lighting control to be small, the laser machining speed needs to be made low, which causes the problem of reducing productivity. There is also the problem that when the depth of a machined hole is so deep as to shield the optical path of the observation optical system, the image of the workpiece cannot be obtained, and the machining state cannot be monitored.

Meanwhile, according to the proposal described in Japanese Patent Laid-Open No. 2004-528991, an observation optical system having a photodiode installed coaxially with an irradiation optical system which irradiates a laser to a workpiece, reflection and emission light intensity from the workpiece is detected with the photodiode, and the machining conditions are changed based on the detection signal. However, emission light from high density plasma (plume) generated during laser machining is detected as well as the reflected light from the workpiece, and therefore, there arises the problem that noise of the detection signal becomes large, and controllability of machining becomes low.

### BRIEF SUMMARY OF THE INVENTION

A laser machining apparatus according to an embodiment of the present invention comprises a laser irradiating part having a laser oscillator and a beam shape converting mechanism, an optical detecting part that detects intensity of reflected light from a workpiece by a laser of a specific wavelength emitted from said laser irradiating part by selectively detecting intensity of light of the specific wavelength and a laser control part that controls at least one of the laser oscillator and the beam shape converting mechanism based on a detection result of said optical detecting part.

A laser machining method according to an embodiment of the present invention comprises irradiating a laser of a specific wavelength to a workpiece to machine the workpiece, selectively detecting intensity of light of the specific wavelength from reflected light from the workpiece while machining the workpiece and controlling the laser based on the detection result.

A manufacturing method of a semiconductor device according to an embodiment of the present invention comprises irradiating a laser of a specific wavelength to a workpiece in which a semiconductor device element is formed on a semiconductor substrate to machine the workpiece, selectively detecting intensity of light of the specific wavelength from reflected light from the workpiece while machining the workpiece and controlling the laser based on the detection result.

### BRIEF DESCRIPTION OF THE DRAWINGS

FIG. 1 is a schematic diagram explaining the structure of a laser machining apparatus 1 according to an embodiment of the present invention;

FIG. 2 is a flow chart of a laser machining method according to the embodiment of the present invention;

FIGS. 3A to 3D are sectional views explaining the structure of a machining area 2a;

FIG. 4 is a diagram showing a measurement result of laser reflected light intensity in an optical detector 42 when a workpiece 2 is laser-machined;

FIGS. 5A and 5B are sectional views explaining the structure of a machining area 2a′;

FIG. 6 is a flow chart of a laser machining method according to another embodiment of the present invention; and

FIG. 7 is a diagram showing a measurement result of laser reflected light intensity in the optical detector 42 when a workpiece 2′ is laser-machined.

### DETAILED DESCRIPTION OF THE EMBODIMENTS OF THE INVENTION

Hereinafter, embodiments of the present invention will be described with reference to the drawings.

### Embodiments of the Present Invention

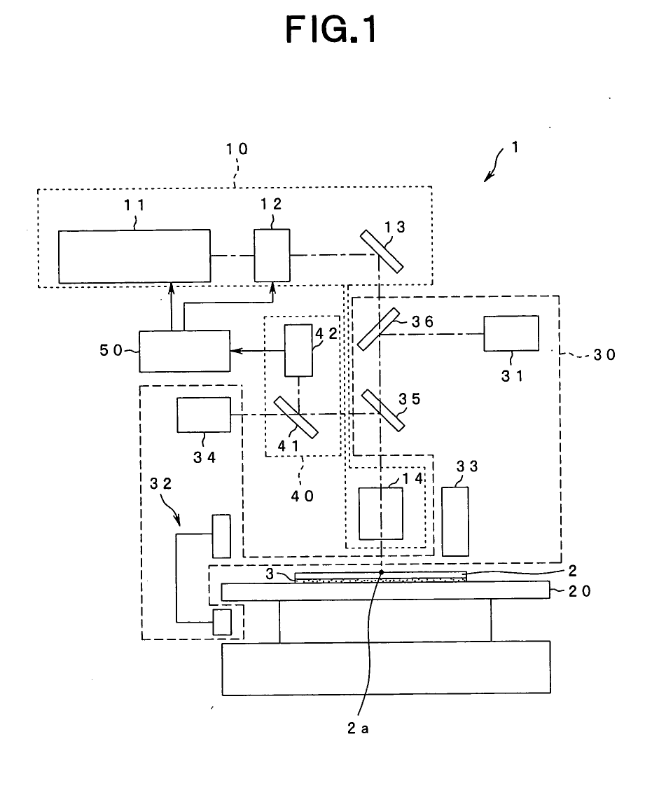

To begin with, the structure of a laser machining apparatus 1 according to the embodiment of the present invention will be described by using FIG. 1. FIG. 1 is a schematic diagram explaining the structure of the laser machining apparatus 1 according to the embodiment of the present invention.

As shown in FIG. 1, the laser machining apparatus 1 comprises a laser optical unit 10 as a laser irradiating part which irradiates a laser to a workpiece 2, a stage 20 which holds and positions the workpiece 2, an alignment unit 30 which performs alignment of the workpiece 2, an optical detecting part 40 which detects reflected light from the workpiece 2, and a laser control part 50 which controls machining conditions based on a detection signal from the optical detecting part 40.

The laser optical unit 10 comprises a laser oscillator 11 which emits a laser for machining the workpiece 2, a beam shape converting mechanism 12 which shapes the beam shape of the laser, a mirror 13 which guides the laser emitted from the laser oscillator 11 to the stage 20, and an objective lens 14 which gathers the laser guided by the mirror 13 to a machining area 2a of the workpiece 2, which is placed on the stage 20.

As the laser oscillator 11, for example, a Q-Switch YAG laser oscillator is used. Laser light oscillated from the Q-Switch YAG laser oscillator includes a fundamental wave (wavelength 1064 nm), a second higher harmonic wave (wavelength 532 nm) and a third higher harmonic wave (wavelength 355 nm). It is possible to select the wavelength absorbed by the workpiece 2 from these wavelengths, and emit the laser light of that wavelength.

The laser light which is irradiated from the laser oscillator 11 is transmitted through the beam shape converting mechanism 12, the mirror 13, and the objective lens 14 in sequence, and is irradiated to the machining area 2a of the workpiece which is placed on the stage 20.

The stage 20 holds the workpiece 2 via an adhesive sheet 3. The stage 20 can be driven in the following four directions, and by using global coordinates determined by an alignment unit 30 that will be described later and by designating concrete coordinates, the machining area 2a of the workpiece 2 can be positioned to the condensed position of the laser which is emitted from the laser optical unit 10. Here, the four directions in which the stage 20 can be driven is an x direction and a y direction that are orthogonal to each other in the horizontal plane orthogonal to the vertical direction, a z direction that is the vertical direction, and a θ direction that is the rotational direction with a center portion of the stage 20 in the vertical direction as an axis.

The alignment unit 30 is a mechanism which adjusts the position of the stage 20 and positions the global coordinates of the workpiece 2 placed on the stage 20, and comprises an observation light source 31, a notch alignment part 32, a rough alignment part 33, a fine alignment part 34, and half tone mirrors 35 and 36.

The observation light source 31 has an ordinary white light source not shown, and emits white light at a time of alignment to illuminate the workpiece 2 placed on the stage 20. The notch alignment part 32 is a mechanism which performs alignment with a notch formed at the workpiece 2 placed on the stage 20 as a reference, and mainly performs alignment in the θ-direction. The rough alignment part 33 is a mechanism which performs alignment with an alignment mark formed at a surface of the workpiece 2 as a reference, and mainly performs rough alignment in the x direction, the y direction and the z direction. The fine alignment part 34 is a mechanism which performs alignment with an alignment mark formed at the surface of the workpiece 2 as a reference, and performs alignment of fine adjustment of the x direction, the y direction, the z direction and the θ direction. The fine alignment part 34 comprises a CCD camera in concrete, and performs fine adjustment of the position of the stage 20 based on an image of, for example, the alignment mark, which is obtained by picking up the reflected light from the workpiece 2 by the white light emitted from the observation light source 31. The half tone mirror 35 is disposed on an optical axis of the laser, and is a mirror having the characteristics that transmit all the light incident on the workpiece 2, and reflect all the light reflected from the workpiece 2. The half tone mirror 36 is disposed on the optical axis of the laser, and is a mirror having the characteristics that transmit all the light which is emitted from the laser oscillator 11 and incident on the workpiece 2, and reflect all the white light emitted from the observation light source 31 and guides the light to the workpiece 2. In FIG. 1, the fine alignment part 34 is disposed coaxially with the optical path of the laser, but it may be disposed to be on a separate axis from the optical path of the laser light as the rough alignment part 33.

The optical detecting part 40 comprises a half tone mirror 41 as a wavelength selection light guide part, and an optical detector 42 that measures the intensity of the reflected light in the machining area 2a of the workpiece 2. The half tone mirror 41 is provided for guiding the light of a specific wavelength to the optical detector 42 from the reflected light from the machining area 2a, and is a mirror having the characteristics that, of the reflected light from the machining area 2a, reflect light of the specific wavelength corresponding to the wavelength of the laser, and transmit the light of the other wavelengths. For example, when in the laser oscillator 11, the laser of the wavelength of 355 nm is selected and irradiated to the workpiece 2, a mirror having the characteristics that selectively reflect only DUV light is used for the half tone mirror 41. The optical detector 42 measures the intensity of the laser reflected light in the machining area 2a of the workpiece 2, which is guided by the half tone mirror 41, and outputs the obtained result to the laser control part 50 as a detection signal. A cutoff filter which cuts the light of wavelengths less than the specific wavelength may be placed between the half tone mirror 41 and the optical detector 42. For example, when the laser of the wavelength of 355 nm is selected in the laser oscillator 11, and the half tone mirror 41 which selectively reflects only the DUV light is used, a cutoff filter which cuts the light of a short wavelength other than the DUV light may be placed.

The laser control part 50 calculates control parameters such as what is obtained by dividing the intensity of reflected light by the intensity of incident light and normalizing the result, which corresponding to reflectivity (hereinafter, described as reflected light normalized intensity in the specification), an average value of the reflected light normalized intensity, and variance of the reflected light normalized intensity, based on the intensity of the laser reflected light, which is the detection signal outputted from the optical detector 42, and changes the irradiation conditions (wavelength, energy, shape, beam diameter, etc. of the laser) of the laser which is irradiated to the machining area 2a when predetermined trigger conditions using these control parameters are satisfied. Various kinds of control conditions such as a control parameter, a trigger condition, and a laser irradiation condition are previously set in the laser control part 50 in accordance with the layer structure of the workpiece 2 or the like.

Next, a laser machining method using the above described laser machining apparatus 1 will be described. In this embodiment, the case where a semiconductor device of, for example, a COC (Chip on chip) structure is manufactured will be described. The semiconductor device of the COC structure is a semiconductor device constructed by disposing a plurality of semiconductor chips in layers to make the semiconductor device compact. In the semiconductor device of the COC structure, for example, a first through hole is provided to penetrate through the semiconductor chip, and after an insulating resin is charged into the through hole, a second through-hole is provided in a central portion of the resin, a conductor is applied to an inner side of the second through hole by plating to construct a connecting plug which electrically connects a front and a back surfaces of the semiconductor chip, the semiconductor chip is electrically connected to other semiconductor chips by this connecting plug and the semiconductor chip is disposed in layer. In this case, the method for forming the first through hole by laser machining so as to penetrate through the semiconductor chip, for example, will be described.

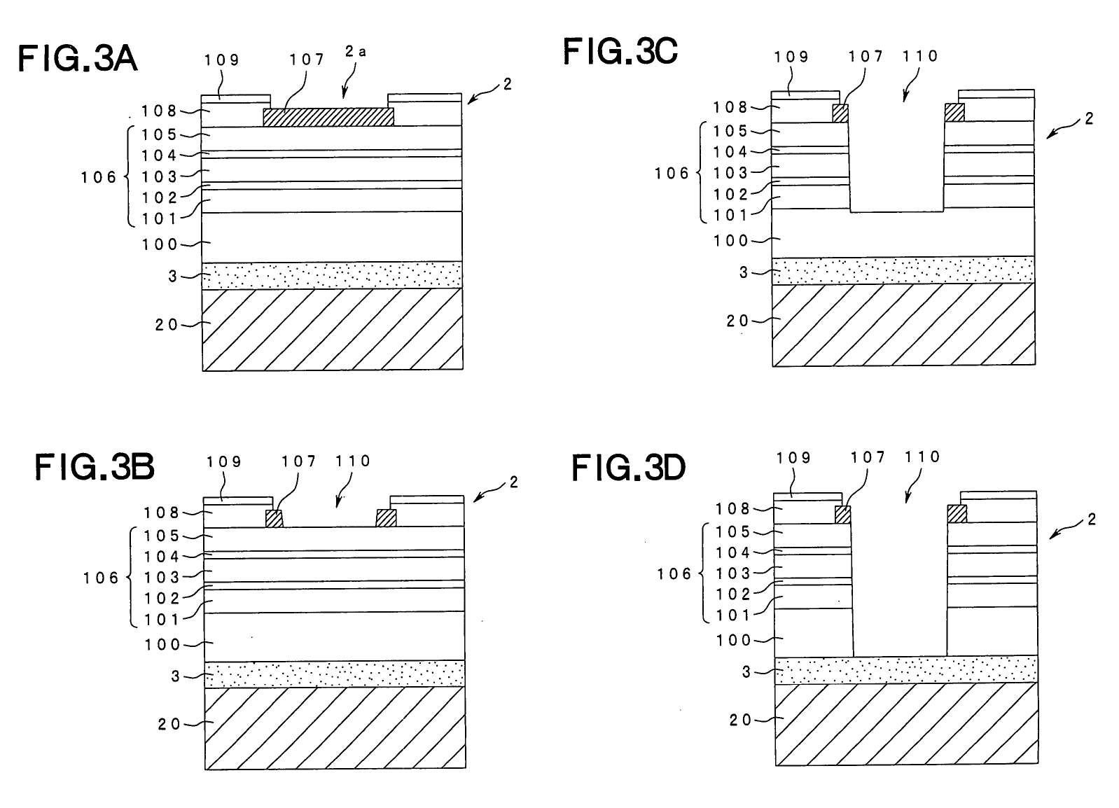

In this embodiment, the machining area 2a in which the first through hole is formed in the semiconductor chip has a layer structure in which an insulating film layer 106 which is constructed on a thin film silicon substrate 100 by stacking a porous silicon oxide (SiO₂) layer 101, a silicon carbide (SiC) layer 102, an organic silicon oxide (SiO₂) layer 103, a silicon carbide/nitride (SiCN) layer 104, and a first silicon oxide (SiO₂) layer 105 in layers, an aluminum electrode pad 107 with aluminum as a material, a second silicon oxide (SiO₂) layer 108, and silicon nitride (Si₃N₄) layer 109 are sequentially deposited, and the aluminum electrode pad 107 is exposed from an opening formed by selectively removing part of the second silicon oxide layer 108 and the silicon nitride layer 109, as shown in, for example, FIG. 3A. FIGS. 3A to 3D are sectional views explaining the structure of the machining area 2a.

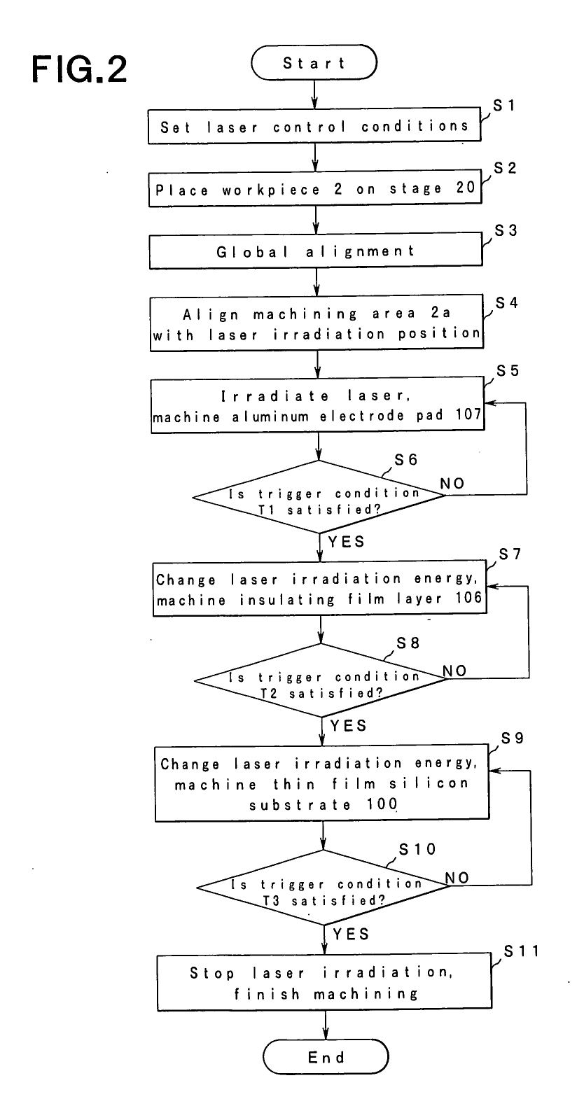

The laser machining method in this embodiment will be described by using FIG. 2. FIG. 2 is a flow chart of the laser machining method according to the embodiment of the present invention.

First, in step S1, various kinds of control conditions are set in the laser control part 50. The control conditions may be set based on the detection signal which is obtained when the sample of the same structure as the workpiece 2 is machined in advance, for example, or they may be set based on the previous machining data which are stored in the laser machining apparatus 1. In this embodiment, the case where the control conditions are set by using the former method will be described.

First, among the control conditions, a setting method of the laser irradiation condition will be described. When the workpiece 2 having the structure shown in FIG. 3A is machined, it is necessary to set the laser irradiation condition which differs among the aluminum electrode pad 107, the insulating film layer 106 and the thin film silicon substrate 100, and to finish machining when the laser machined hole 110 penetrates through the thin film silicon substrate 100 and reaches the adhesive sheet 3. Since the aluminum electrode pad 107 has high mechanical strength, it is desirably machined in a short time with high energy with energy of the laser set at 1.5 J/(cm²/pulse) to 5.0 J/(cm²/pulse). On the other hand, the insulating film layer 106 has low mechanical strength, and therefore, in order to machine the insulating film layer 106 into a favorable shape without occurrence of a crack or the like, energy of the laser needs to be reduced to about 0.4 J/(cm²/pulse) to 1.0 J/(cm²/pulse). Since in the thin film silicon substrate 100 on the lowest layer, only the surface is melted and the machined hole 110 is not formed with the weak energy at the same level as that for the insulating film layer 106, the thin film silicon substrate 100 needs to be machined with the high energy at the same level as that for the aluminum electrode pad 107.

Thus, in this embodiment, the irradiation energy of the laser is set at 3 J/(cm²/pulse) for the aluminum electrode pad 107, at 0.5 J/(cm²/pulse) for the insulating film layer 106, and at 2 J/(cm²/pulse) for the thin film silicon substrate 100. As for the wavelength of the laser, the third higher harmonic wave (wavelength 355 nm) is used for the aluminum electrode pad 107, the insulating film layer 106 and the thin film silicon substrate 100, and the laser irradiation shape and the beam diameter are set so as to machine all the layers with a fixed shape and beam diameter.

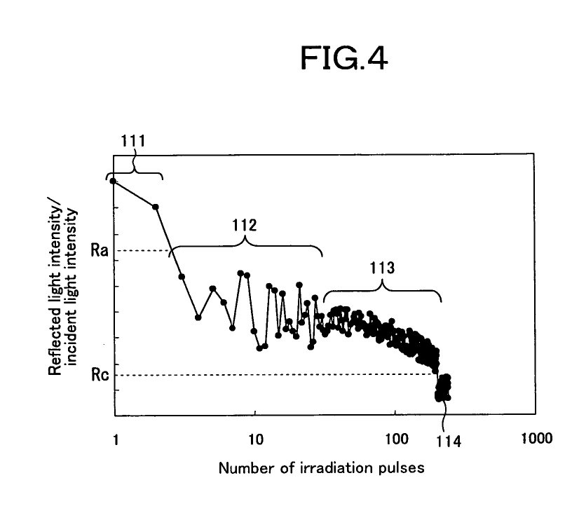

Next, a setting method of the control parameters and trigger condition in this embodiment will be described by using FIG. 4. FIG. 4 is a measurement result of the laser reflected light intensity in the optical detector 42 when the workpiece 2 is laser-machined. In the measurement result shown in FIG. 4, the value which is obtained by dividing the intensity of the laser reflected light by the intensity of the laser incident light and normalizing the quotient, namely, the value corresponding to the reflectivity is plotted to the number of irradiation pulses of the laser to the sample.

First, the aluminum electrode pad 107 is machined, and since the material of the aluminum pad 107 is metal, the reflected light normalized intensity of the laser has a high value (refer to the plot 111 in FIG. 4). When the laser machined hole 110 penetrates through the aluminum electrode pad 107, the section of the machining area 2a is in the state as shown in FIG. 3B, and the insulating film layer 106 is exposed to a bottom portion of the machined hole 110. In the insulating film layer 106, the reflected light normalized intensity of the laser has a lower value as compared with the reflected light normalized intensity in the aluminum electrode pad 107. The insulating film layer 106 is formed by the five layers that are the porous silicon oxide (SiO₂) layer 101, the silicon carbide (SiC) layer 102, the organic silicon oxide (SiO₂) layer 103, the silicon carbide/nitride (SiCN) layer 104, and the first silicon oxide (SiO₂) layer 105, and the optical absorption coefficients of these layers 101 to 105 are at small values. Accordingly, when the laser is incident on the insulating film layer 106, it causes multiple scattering in the films, and variation of reflected light normalized intensity of the laser becomes large (refer to the plot 112 in FIG. 4).

When the laser machined hole 110 penetrates through the insulating film layer 106, the section of the machining area 2a is in the state shown in FIG. 3C, and the thin film silicon substrate 100 is exposed to the bottom portion of the machined hole 110. Since in the thin film silicon substrate 100, multiple scattering of the laser does not occur, the variation of the reflected light normalized intensity of the laser becomes small and the reflected light normalized intensity shows a substantially constant value. However, when the depth of the laser machined hole 110 becomes deep, scattering of the laser increases in the machined hole 110, and therefore, the intensity of the detected laser reflected light gradually reduces, with which, the reflected light normalized intensity also reduces (refer to the plot 113 in FIG. 4). When the laser machined hole 110 penetrates through the thin film silicon substrate 100, the section of the machining area 2a is in the state as shown in FIG. 3D, and the base adhesive sheet 3 is exposed to the bottom portion of the machined hole 110. In this case, the adhesive sheet 3 is made of a resin, and since a resin is low in laser reflectivity as compared with silicon, the detected reflected light normalized intensity abruptly reduces (refer to the plot 114 in FIG. 4).

Thus, in this embodiment, a first control parameter P1 for detecting that the laser penetrates through the aluminum electrode pad 107 and reaches the insulating film layer 106 is set as the value of the reflected light normalized intensity, and a trigger condition T1 is set as the first control parameter P1 being Ra or less. A second control parameter P2 for detecting that the laser penetrates through the insulating film layer 106 and reaches the thin film silicon substrate 100 is set as the variation in the reflected light normalized intensity, and a trigger condition T2 is set as the value of the second control parameter P2 being Rb or less. Further, a third control parameter P3 for detecting that the laser penetrates through the thin film silicon substrate 100 and reaches the adhesive sheet 3 is set as the value of reflected light normalized intensity, and a trigger condition T3 is set as the value of the third control parameter P3 being Rc or less. The values of Ra to Rc are concretely calculated from the detection result shown in FIG. 4.

When the control conditions are set in the laser control part 50 as described above, the workpiece 2 is placed on the stage 20 via the adhesive sheet 3 in step S2. Next, in step S3, global alignment of the workpiece 2 is performed by the alignment unit 30, and the global coordinates are set. Subsequently, in step S4, the stage 20 is moved so that the machining area 2a of the workpiece 2 is disposed at the irradiation position of the laser.

Next, in step S5, laser is emitted from the laser oscillator 11, and the aluminum electrode pad 107 is machined. At this time, the laser oscillator 11 and the beam shape converting mechanism 12 are controlled by the laser control part 50 so that the laser is irradiated to the machining area 2a under the control conditions set in step S1, namely, the laser of the third higher harmonic wave (wavelength 355 nm) is irradiated to the machining area 2a in a predetermined beam shape with a predetermined beam diameter and energy of 3 J/(cm²/pulse).

During machining of the aluminum electrode pad 107, the optical detector 42 always measures the intensity of the laser reflected light from the machining area 2a, and outputs the obtained result to the laser control part 50 as a detection signal. The laser control part 50 calculates the value of the reflected light normalized intensity that is the first control parameter P1 set in step S1, and always monitors whether the trigger condition T1 is satisfied or not (step S6). In step S6, when the trigger condition T1 is not satisfied, namely, when the value of the reflected light normalized intensity is larger than Ra, the laser control part 50 determines that the laser machined hole 110 does not penetrates through the aluminum electrode pad 107 and does not reach the insulating film layer 106, and continues machining of the aluminum electrode pad 107 in step S5 without changing the control conditions.

On the other hand, when the trigger condition T1 is satisfied, namely, the value of the reflected light normalized intensity is Ra or less in step S6, the laser control part 50 determines that the laser machined hole 110 penetrates through the aluminum electrode pad 107 and reaches the insulating film layer 106, and proceeds to step S7 and changes the control conditions. In this embodiment, the determination processing in step S6 is performed each time the laser is irradiated by 1 pulse. For example, in the case where the film thickness of the aluminum electrode pad 107 is 1 to 1.5 μm, the machined hole 110 penetrates through the aluminum electrode pad 107 and reaches the insulating film layer 106 when the laser is irradiated by two to three pulses.

In step S7, a control signal is outputted to the laser oscillator 11 from the laser control part 50 so that the laser is irradiated to the machining area 2a with the energy of 0.5 J/(cm²/pulse) in accordance with the control conditions set in step S1. The laser oscillator 11 changes the energy of the laser which it emits to 0.5 J/(cm²/pulse) from 3 J/(cm²/pulse) up to that time, and machines the insulating film layer 106.

During machining of the insulating film layer 106, the optical detector 42 always measures the intensity of the laser reflected light from the machining area 2a, and outputs the obtained result to the laser control part 50 as the detection signal. The laser control part 50 calculates the value of variance of the reflected light normalized intensity that is the second control parameter P2 which is set in step S1, and always monitors whether the trigger condition T2 is satisfied or not (step S8). When the trigger condition T2 is not satisfied, namely, the value of variance of the reflected light normalized intensity is larger than Rb in step S8, the laser control part 50 determines that the laser machined hole 110 does not penetrate through the insulating film layer 106, and does not reach the thin film silicon substrate 100, and continues machining the insulating film layer 106 in step S7 without changing the control conditions.

On the other hand, when the trigger condition T2 is satisfied, namely, the value of variance of the reflected light normalized intensity is Rb or less, the laser control part 50 determines that the laser machined hole 110 penetrates through the insulating film layer 106, and reaches the thin film silicon substrate 100, and proceeds to step S9 and changes the control conditions. As the determination processing in step S6, the determination processing in step S8 is also performed each time the laser is irradiated by one pulse.

In step S9, the laser control part 50 outputs the control signal to the laser oscillator 11 so that the laser is irradiated to the machining area 2a with the energy of 2 J/(cm²/pulse) in accordance with the control conditions set in step S1. The laser oscillator 11 changes the energy of the laser which it emits to 2 J/(cm²/pulse) from 0.5 J/(cm²/pulse) up to that time, and machines the thin film silicon substrate 100.

During machining of the thin film silicon substrate 100, the optical detector 42 always measures the intensity of the laser reflected light from the machining area 2a, and outputs the obtained result to the laser control part 50 as the detection signal. The laser control part 50 calculates the value of the reflected light normalized intensity that is the third control parameter P3 set in step S1 based on the detection signal, and always monitors whether the trigger condition T3 is satisfied or not (step S10). When the trigger condition T3 is not satisfied, namely, the value of the reflected light normalized intensity is larger than Rc in step S10, the laser control part 50 determines that the laser machined hole 110 does not penetrate through the thin film silicon substrate 100 and does not reach the adhesive sheet 3, and continues machining the thin film silicon substrate 100 in step S9 without changing the control conditions.

On the other hand, when the trigger condition T3 is satisfied, namely, the value of the reflected light normalized intensity is Rc or less in step S10, the laser control part 50 determines that the laser machined hole 110 penetrates through the thin film silicon substrate 100 and reaches the adhesive sheet 3, and proceeds to step S11 and changes the control conditions. The determination processing in step S10 is also performed at each time the laser is irradiated by one pulse as the determination processing in steps S6 and S8.

In step S11, the laser control part 50 outputs the control signal to reduce the laser energy to 0 J/(cm²/pulse), namely to stop the laser irradiation to the laser oscillator 11. The laser oscillator 11 follows the control signal which it receives from the laser control part 50, stops the laser irradiation, and finishes the laser machining of the workpiece 2.

As described above, in this embodiment, the optical detector 40 detects the intensity of the laser reflected light of a specific wavelength from the workpiece, which corresponds to the wavelength of the irradiated laser, and thereby, the machining state of the workpiece can be favorably monitored. By immediately and properly controlling the irradiation conditions of the laser corresponding to the change in the intensity of the laser reflected light of a specific wavelength, the through hole 110 can be opened in only the workpiece 2 without reducing the machining speed, and with the base adhesive sheet 3 hardly machined, and controllability of machining can be enhanced without reducing productivity.

The laser machining apparatus and the laser machining method of the present invention can be applied not only to the case where the through hole is opened in the stacked structure on the thin film silicon substrate 100 on which the semiconductor device element is formed as shown in FIGS. 3A to 3D, but also to the case where laser machined holes are formed in the workpieces having various structures. They are applicable to the case where the insulating resin is charged into the through hole formed as described above, and thereafter, the second through hole is provided in the central portion of the resin to produce the semiconductor device of a COC structure, for example.

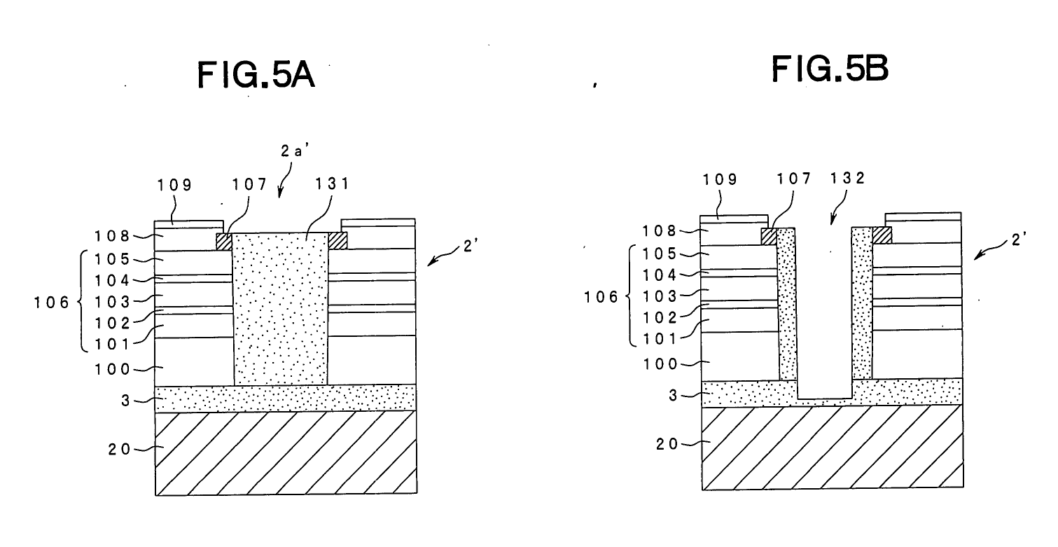

The structure of a machining area 2a′ of a workpiece 2′ in this case is shown in FIG. 5A. FIGS. 5A and 5B are sectional views explaining the structure of the machining area 2a′ in another embodiment of the present invention. The machining area 2a′ has the structure in which, a resin 131 such as polyimide, for example, is charged inside the laser machined hole 110 shown in FIG. 3D.

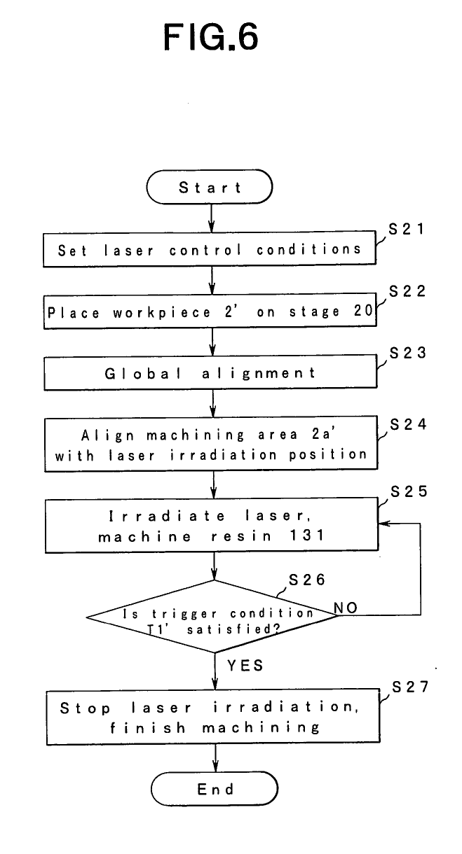

A laser machining method relating to the workpiece 2′ of the structure shown in FIG. 5A will be described by using FIG. 6. FIG. 6 is a flow chart of the laser machining method according to another embodiment of the present invention.

First, in step S21, various control conditions are set in the laser control part 50 by the same method as in step S1 in FIG. 2. First, the laser irradiation condition will be described. Energy of 0.4 J/(cm²/pulse) to 1.0 J/(cm²/pulse) is generally used for the energy used in laser machining of an embedded resin. Thus, in this embodiment, irradiation energy of the laser is set at 0.5 J/(cm²/pulse). The third higher harmonic wave (wavelength 355 nm) is set for the laser wavelength, and the same shape as the laser machined hole 110 as shown in FIG. 3D is set for the irradiation shape of the laser, and a smaller diameter than the diameter of the laser machined hole 110 shown in FIG. 3D is set for the beam diameter.

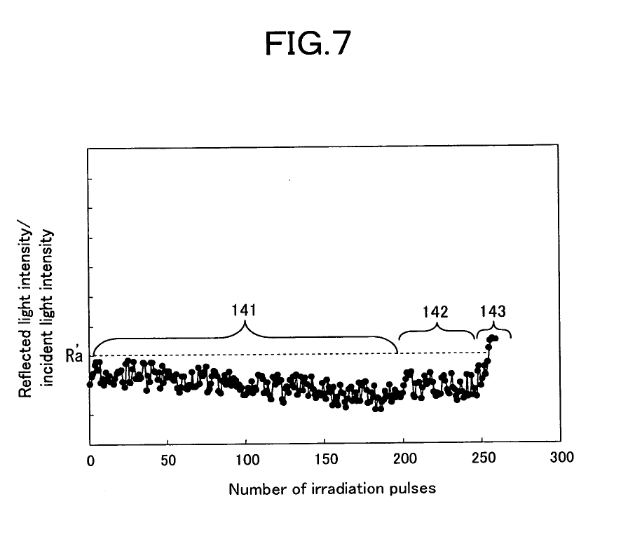

Next, the control parameter and the trigger condition will be described by using FIG. 7. FIG. 7 is the measurement result of the laser reflected light intensity in the optical detector 42 when the workpiece 2′ is laser-machined. During machining of the resin 131, the reflectivity of laser indicates a low value. However, as the machined depth of a machined hole 132 becomes deeper, scattering of the reflected light inside the machined hole 132 increases, and therefore, the detection intensity of the reflected light reduces. With this, the reflected light normalized intensity slightly reduces (refer to the plot 141 in FIG. 7). When the laser machined hole 132 penetrates through the resin 131, the adhesive sheet 3 is exposed to a bottom portion of the machined hole 132. The adhesive sheet 3 is also made of a resin as the resin 131, the reflected light normalized intensity slightly changes by the difference amount of the optical constants of both the materials (refer to the plot 142 in FIG. 7).

However, the variation in the reflected light normalized intensity in the resin 131 and the adhesive sheet 3 is larger than the difference in the reflected light normalized intensity between the resin 131 and the adhesive sheet 3, and therefore, it is difficult to set the value of the reflected light normalized intensity as the control parameter. It is also difficult to set the other control parameter candidate items such as variance of the reflected light normalized intensity as the control parameter since the difference between the resin 131 and the adhesive sheet 3 is small. Accordingly, it is difficult to set the trigger condition to detect that the bottom portion of the machined hole 132 reaches the adhesive sheet 3, and the adhesive sheet 3 continues to be machined under the same laser machining condition as the resin 131. Machining cuttings of the resin occurs as a result of machining the adhesive sheet 3, and there is the possibility of the machining cuttings adhering to the wall surface of the machined hole 132. However, the wall surface of the machined hole 132 is of the same material (resin) as the machining cuttings, and therefore, there is hardly the possibility of characteristic deficiencies of the device being directly caused by the machining cuttings.

When the adhesive sheet 3 is machined by laser, the section of the machining area 2a′ is in the state shown in FIG. 5B, and the bottom portion of the machined hole 132 approaches the surface of the stage 20. Since the stage 20 is made of a metal in this case, and the metal is higher in reflectivity of laser as compared with the resin, the reflected light normalized intensity detected abruptly rises as it receives the influence of reflection from the stage 20 as the bottom portion of the machined hole 132 approaches the stage 20 (refer to the plot 143 in FIG. 7). Thus, the value of the reflected light normalized intensity is set as the control parameter P1′, and as the trigger condition T1′, the value of the control parameter P1′ being Ra′ or more is set. Thereby, machining of the adhesive sheet 3 is limited to the minimum necessary amount, and the laser machining can be finished at least before the machined hole 132 reaches the stage 20.

When the control conditions are set in the laser control part 50 as described above, the same processing as in step S2 to step S4 in FIG. 2 is performed in step S22 to step S24, and the workpiece 2′ is kept standby in the state capable of being laser-machined.

Next, in step S25, laser is emitted from the laser oscillator 11, and the resin 131 is machined. At this time, the laser oscillator 11 and the beam shape converting mechanism 12 are controlled by the laser control part 50 so that the laser is irradiated to the machining area 2a′ under the control conditions set in step S21, namely, the laser of the third higher harmonic wave (wavelength 355 nm) is irradiated to the machining area 2a′ with a predetermined beam shape and beam diameter, and energy of 0.5 J/(cm²/pulse).

During machining, the optical detector 42 always measures the intensity of the laser reflected light from the machining area 2a′, and outputs the obtained result to the laser control part 50 as the detection signal. The laser control part 50 calculates the value of the reflected light normalized intensity that is the control parameter P1′ set in step S21 based on the detection signal, and always monitors whether the trigger condition T1′ is satisfied or not (step S26). When the trigger condition T1′ is not satisfied, namely, the value of the reflected light normalized intensity is smaller than Ra′ in step S26, the laser control part 50 determines the possibility that the laser machined hole 132 does not penetrate through the resin 131, and continues the machining in step S25 without changing the control conditions.

On the other hand, when the trigger condition T1′ is satisfied, namely, the value of the reflected light normalized intensity is Ra′ or more in step S26, the laser control part 50 determines that the laser machined hole 132 penetrates through the resin 131, and proceeds to step S27 and changes the control conditions. The determination processing in step S26 is performed each time the laser is irradiated by one pulse. In step S27, the laser control part 50 outputs a control signal to reduce the energy of the laser to 0 J/(cm²/pulse), namely, to stop the laser irradiation to the laser oscillator 11. The laser oscillator 11 follows the control signal which it receives from the laser control part 50, stops the laser irradiation and finishes the laser machining of the workpiece 2′.

As described above, in the case of machining the resin which is the same material as the base adhesive sheet 3, by immediately and properly controlling the irradiation conditions of the laser corresponding to the change in the intensity of the laser reflected light of a specific wavelength, machining of the adhesive sheet 3 is limited to the minimum, the machined hole 132 can be opened in the workpiece 2′ without machining at least the stage 20, and controllability of machining can be enhanced without reducing productivity.

As described above, in the above described embodiment, the case of machining the through hole to produce the semiconductor device of, for example, the COC structure is described as an example, but the present invention is not limited to the above described embodiment, and various changes, modifications or the like are possible in the range without departing from the spirit of the present invention.

The present invention is applicable to the case where the semiconductor substrate loaded with a plurality of semiconductor chips is diced by using laser and divided into individual semiconductor chips. In this case, the laser is scanned along a machining route (dicing line) on the semiconductor substrate while the irradiation position of the laser is gradually shifted. Since the semiconductor substrate is not generally divided by scanning the laser along the machining route only once, the laser needs to be scanned on the machining route several times and needs to be stopped when the semiconductor substrate is divided and the laser reaches the base adhesive sheet or the like. Thus, machining is performed, for example, such that the previously decided control conditions of stopping the laser when the average value of the reflected light normalized intensity during one scanning on the machining route is a predetermined value or less and the like are set in the laser control part 50, whereby controllability of machining can be enhanced without reducing productivity. Further, at this time, machining may be performed by setting the control condition to make the laser diameter of the laser smaller at the point of time when monitoring the groove formed along the machining route penetrates through the insulating film layer or the like of the semiconductor substrate and reaches the silicon substrate.

When proper laser irradiation energy machines an unknown layer, the laser machining apparatus and the laser machining method of the present invention can be applied. If the laser is irradiated to a layer weak in mechanical strength such as an insulating film layer with the energy exceeding the proper energy, there arises the possibility of causing a crack in the film to make poor machined shape and causes characteristic deficiencies. Thus, machining is performed, for example, by setting the initial condition of the laser irradiation energy at a low value, and by setting the control condition to the effect that when the reflected light normalized intensity does not change during a fixed time, irradiation energy of the laser is increased by a predetermined value in the laser control part 50, whereby, machining can be performed with proper laser irradiation energy, and controllability of machining can be enhanced without reducing productivity.

As described above, according to this embodiment, the laser machining apparatus capable of favorably monitoring the machining state of a workpiece without reducing productivity, and capable of enhancing controllability of machining, and a laser machining method and manufacturing method of a semiconductor device can be realized.

Having described the embodiments of the invention referring to the accompanying drawings, it should be understood that the present invention is not limited to those precise embodiments and various changes and modifications thereof could be made by one skilled in the art without departing from the spirit or scope of the invention as defined in the appended claims.

What is claimed is:

1. A laser machining apparatus, comprising:
a laser irradiating part having a laser oscillator and a beam shape converting mechanism;
an optical detecting part that detects intensity of reflected light from a workpiece by a laser of a specific wavelength emitted from said laser irradiating part by selectively detecting intensity of light of the specific wavelength; and
a laser control part that controls at least one of the laser oscillator and the beam shape converting mechanism based on a detection result of said optical detecting part.

2. The laser machining apparatus according to claim 1,
wherein said laser control part controls energy of the laser emitted from the laser oscillator, and/or a beam shape of the laser formed by the beam shape converting mechanism, in accordance with a detection signal which is outputted from said optical detecting part.

3. The laser machining apparatus according to claim 1,
wherein said laser control part calculates a control parameter based on a detection signal outputted from said optical detecting part, and when the control parameter satisfies a predetermined trigger condition, said laser control part changes energy of the laser emitted from the laser oscillator and/or a beam shape of the laser formed by the beam shape converting mechanism.

4. The laser machining apparatus according to claim 3,
wherein the control parameter is a value of reflectivity of the laser, or a variation of the value of the reflectivity of the laser.

5. The laser machining apparatus according to claim 3,
wherein determination whether the control parameter satisfies the trigger condition or not is performed, each time the laser is emitted by a predetermined number of pulses from said laser irradiating part.

6. The laser machining apparatus according to claim 1,
wherein said optical detecting part has an optical detector that measures intensity of light of the specific wavelength, and a wavelength selection light guide part that is provided between the workpiece and the optical detector, and selectively guides the light of the specific wavelength to the optical detector.

7. The laser machining apparatus according to claim 6,
wherein said optical detecting part further has a cutoff filter that is provided between the optical detector and the wavelength selection light guide part, and cuts light of a wavelength that is less than the specific wavelength.

8. A laser machining method, comprising:
irradiating a laser of a specific wavelength to a workpiece to machine the workpiece;
selectively detecting intensity of light of the specific wavelength from reflected light from the workpiece while machining the workpiece; and
controlling the laser based on the detection result.

9. The laser machining method according to claim 8,
wherein based on the detection result, energy of the laser, and/or a beam shape of the laser are/is controlled.

10. The laser machining method according to claim 8, further comprising:
setting a control condition of the laser, before irradiating the laser to the workpiece,
wherein based on the detected intensity of the light of the specific wavelength, the laser is automatically controlled in accordance with the set control condition of the laser.

11. The laser machining method according to claim 8,
wherein a control parameter is calculated based on the detection result, and when the control parameter satisfies a predetermined trigger condition, energy of the laser and/or a beam shape of the laser are/is changed.

12. The laser machining method according to claim 11,
wherein the control parameter is a value of reflectivity of the laser, or a variation of the value of the reflectivity of the laser.

13. The laser machining method according to claim 11,
wherein determination whether the control parameter satisfies the trigger condition or not is performed, each time the laser is emitted by a predetermined number of pulses.

14. The laser machining method according to claim 8,
wherein by causing the reflected light to be reflected by a half tone mirror and guided to an optical detector, the intensity of the light of the specific wavelength is selectively detected.

15. A manufacturing method of a semiconductor device, comprising:
irradiating a laser of a specific wavelength to a workpiece in which a semiconductor device element is formed on a semiconductor substrate to machine the workpiece;
selectively detecting intensity of light of the specific wavelength from reflected light from the workpiece while machining the workpiece; and
controlling the laser based on the detection result.

16. The manufacturing method of a semiconductor device according to claim 15, further comprising setting a control condition of the laser, before irradiating the laser to the workpiece,
wherein based on the detected intensity of the light of the specific wavelength, the laser is automatically controlled in accordance with the set control condition of the laser.

17. The manufacturing method of a semiconductor device according to claim 15,
wherein a control parameter is calculated based on the detection result, and when the control parameter satisfies a predetermined trigger condition, energy of the laser and/or a beam shape of the laser are/is changed.

18. The manufacturing method of a semiconductor device according to claim 17,
wherein the control parameter is a value of reflectivity of the laser, or a variation of the value of the reflectivity of the laser.

19. The manufacturing method of a semiconductor device according to claim 16,
wherein the workpiece is of a layered structure in which an insulating film and a metal are accumulated above the semiconductor substrate.

20. The manufacturing method of a semiconductor device according to claim 19,
wherein the setting a control condition of the laser is the one to set different control conditions of the laser for the semiconductor substrate, the insulating film and the metal respectively to control the laser based on the detected intensity of the light so that the semiconductor substrate, the insulating film and the metal may be machined according to the respective control conditions.
